(19) United States
(12) Patent Application Publication
(10) Pub. No.: US 2020/0177335 A1
(43) Pub. Date: Jun. 4, 2020

(54) SOUNDING REFERENCE SIGNALS (SRS) IN NEW RADIO (NR) COMMUNICATION SYSTEMS

(71) Applicant: NEC CORPORATION, Tokyo (JP)

(72) Inventors: Yasushi MARUTA, Tokyo (JP); Duong PHAM, Victoria (AU)

(73) Assignee: NEC CORPORATION, Minato-ku (JP)

(21) Appl. No.: 16/631,526

(22) PCT Filed: Mar. 2, 2018
(86) PCT No.: PCT/JP2018/009362

§ 371 Date: Jan. 16, 2020

(30) Foreign Application Priority Data
Jul. 19, 2017 (AU) 2017902832

(51) Int. Cl. H04L 5/00; H04L 27/26

(52) U.S. Cl. CPC H04L 5/0048; H04L 27/2613

(57) ABSTRACT

A New Radio (NR) system and a method for transmitting sounding reference signals in a new radio communications system is provided that enables mutual orthogonality to be maintained between SRS resources of different UEs. The system an eNodeB and a plurality of UEs, and the method includes: generating, at a UE, a base sequence based upon a sequence number received from the eNodeB; generating a plurality of blocks from the base sequence by applying cyclic-shifts to the base sequence; and generating a sounding reference signal by concatenating the cyclically shifted blocks. The sounding reference signal is then transmitted to the eNodeB. By using the same Zadoff-Chu base sequence with different cyclic shifts among overlapped UEs, mutual orthogonality of the SRS of each UE is maintained.

### TECHNICAL FIELD

The present invention relates to channel quality signalling in advanced wireless communication networks, and in particular in New Radio (NR) Multi-User Multiple Input Multiple Output (MU-MIMO) communication systems.

The following abbreviations are used herein.

| | |
|---|---|
| LTE | Long Term Evolution |
| MIMO | Multiple Input Multiple Output |
| MU | Multiple User |
| NR | New Radio |
| PRB | Physical Resource Block |
| UE | User Equipment |
| RE | Resource Element |
| SRS | Sounding Reference Signal |
| ZC | Zadoff Chu |
| N_{sc}^{RB} | Number of subcarriers in a Physical Resource Block |
| | (normally 12 subcarriers) |

### BACKGROUND ART

Wireless communication systems are widely known in which base stations (also known as eNodeBs (eNBs)) communicate with mobile devices (also known as user equipments (UEs)) which are within range of the eNodeB. Each eNodeB divides its available bandwidth, i.e. frequency and time resources, into different resource allocations for the different UEs.

In order to efficiently utilise the bandwidth, the eNodeB may, among other things, estimate the uplink channel quality and use this information for uplink scheduling. Sounding reference signals (SRS) are one way of measuring uplink channel quality in existing LTE systems.

Much attention has now, however, been focused on the development of next generation technology and services, and in particular to new radio (NR) systems. These NR systems are developed to both satisfy urgent market needs, together with more long-term requirements, and are thus very broad.

The use of LTE-like sounding reference signalling methods in NR systems has been considered in 3GPP TSG Radio Access Network (RAN) in the development of NR systems. However, LTE-like sounding reference signalling methods are considered to provide inflexible signalling. In particular, it is suggested that severe scheduling restrictions would be required to ensure mutual orthogonality amongst all users. Such severe scheduling restrictions are clearly undesirable.

As such, there is clearly a need for an improved method for transmitting sounding reference signals in a new radio (NR) communication system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to method for transmitting sounding reference signals in a new radio (NR) communication system, which may at least partially overcome at least one of the abovementioned disadvantages or provide the consumer with a useful or commercial choice.

With the foregoing in view, the present invention in one form, resides broadly in a method for transmitting sounding reference signals in a new radio communications system including an eNodeB and a plurality of UEs, the method including:

generating, at a UE, a base sequence based upon a sequence number received from the eNodeB;

generating a plurality of blocks from the base sequence by applying cyclic-shifts to the base sequence;

generating a sounding reference signal by concatenating the cyclically shifted blocks; and

transmitting the sounding reference signal to the eNodeB,

wherein the plurality of blocks comprises 48 orthogonal blocks, and each of the plurality of blocks is 4 Physical Resource Blocks (PRBs) long.

Advantageously, the method enables mutual orthogonality to be maintained between SRS resources of the different UEs, which in turn enables more accurate uplink channel quality estimation. Furthermore, the method is aligned with existing LTE-based methods.

The base sequence r̅_{u,v} may be determined according to 3GPP specification TS 36.211 V14.1.0 (2016-12), Section 5.5.1.1.

Preferably, the base sequence r̅_{u,v} is determined according to:

r̅_{u,v}(n)=x_{q}(nmod N_{ZC}^{RS})0≤n<M_{sc}^{RS} with u∈{0,1, . . . ,29}

where the q^{th} root ZC sequence is defined by

$${x}_{q} ( m ) = {e}^{- j \frac{π qm ( m + 1 )}{{N}_{ZC}^{RS}}} , 0 \leq m \leq {N}_{ZC}^{RS} - 1$$

with q given by

q=└q̅+½┘+v·(−1)^{└2q̅┘}

q̅=N_{ZC}^{RS}·(u+1)/31

and where M_{SC}^{RS}=4N_{SC}^{RB}=48, N_{ZC}^{RS}=47 and v=0.

The cyclically-shifted base sequence r (n) may be determined according to 3GPP specification TS 36.211 V14.1.0 (2016-12), Section 5.5.3.1.

The cyclically-shifted base sequence r_{u,v}^{(α\tilde{p})} (n) may be determined according to 3GPP specification TS 36.211 V14.1.0 (2016-12), Section 5.5.3.1.

Preferably, the cyclically-shifted base sequence rᵤᵥ^{(α\tilde{p})} (n) is determined according to:

rᵤᵥ^{(α\tilde{p})}(n)=e^{jα\tilde{p}n}r̅_{u,v}(n), 0≤n<M_{SC}^{RS}

where α\tilde{p} is the cyclic shift.

Preferably, the cyclic shift α\tilde{p} is determined according to:

$${α}_{\tilde{p}} = 2 π \frac{{n}_{SRS}^{cs , \tilde{p}}}{{n}_{SRS}^{cs , max}}$$

$${n}_{SRS}^{cs , \tilde{p}} = ( {n}_{SRS}^{cs} + \frac{{n}_{SRS}^{cs , max} \tilde{p}}{{N}_{ap}} ) mod {n}_{SRS}^{cs , max} , \\ \tilde{p} ∈ \{ 0 , 1 , … , {N}_{ap} - 1 \}$$

where n_{SRS}^{CS∈{}0, 1, . . . , n_{SRS}^{cs,max}} and Nₐₚ is the number of antenna ports used for sounding reference signal transmission.

Preferably, the blocks are concatenated according to an instruction received from the eNodeB.

Preferably, the sounding reference signal is transmitted such that blocks thereof are aligned with blocks of sounding reference signals of other UEs.

Preferably, the cyclic shift used by each UE at each block is signalled by the eNodeB to the UEs.

Preferably, different cyclic shifts are used by different UEs in corresponding blocks. Preferably, the same base sequence is used by the UEs in corresponding blocks.

Preferably, the eNodeB is configured to schedule SRS resources at each of the UEs such that mutual orthogonality is maintained between the SRS resources of the different UEs.

In another form, the invention resides broadly in a new radio communications systems including an eNodeB and a plurality of UEs, wherein each UE is configured to:

generate, a base sequence based upon a sequence number received from the eNodeB;

generate a plurality of blocks from the base sequence by applying cyclic-shifts to the base sequence;

generate a sounding reference signal by concatenating the cyclically shifted blocks; and

transmit to the sounding reference signal to the eNodeB.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings.

FIG. 1 illustrates a MU-MIMO system, according to an embodiment of the present invention.

FIG. 2 illustrates a method of generating an Sounding Reference Signal (SRS) sequence at a UE, for transmission to the eNodeB 105, according to an embodiment of the present invention.

FIG. 3 illustrates an exemplary SRS sequence transmission diagram 300, according to an embodiment of the present invention.

Preferred features, embodiments and variations of the invention may be discerned from the following Description of Embodiments which provides sufficient information for those skilled in the art to perform the invention. The Description of Embodiments is not to be regarded as limiting the scope of the preceding Summary of the Invention in any way.

### DESCRIPTION OF EMBODIMENTS

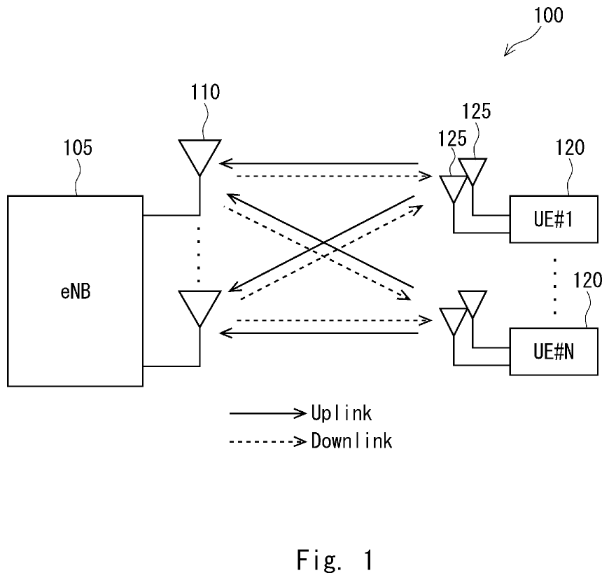

FIG. 1 illustrates a MU-MIMO system 100, according to an embodiment of the present invention. The MU-MIMO system 100 includes an eNodeB 105 including a plurality of antennas 110. The eNodeB 105 is configured to communicate with a plurality of different UEs 120, each equipped with multiple antennas 125.

As outlined in further detail below, the UEs 120 transmit sounding reference signals (SRS) to the eNodeB 105 to enable the eNodeB 105 to estimate the UL channel quality. In short, the SRS comprise sequences known to the eNodeB 105, transmitted from the UEs 120 in the UL direction, enabling the eNodeB 105 to estimate UL channel quality based upon reception thereof.

The eNodeB 105 schedules SRS resources, and can schedule SRS resources to multiple UEs 120 such that the resources comprise fully and/or partially overlapping in SRS time-frequency resource elements (REs). The SRS are Zadoff Chu (ZC) based, and multiple SRS resources can share the same root sequence values in the overlapping REs, which allows for low or zero mutual cross-correlation.

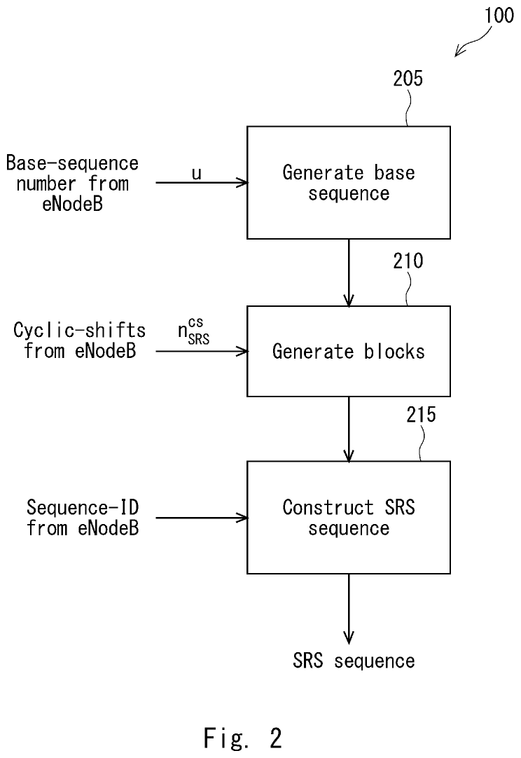

FIG. 2 illustrates a method 200 of generating an SRS sequence at a UE 120, for transmission to the eNodeB 105, according to an embodiment of the present invention.

Initially, and at step 205, a base sequence r̅_{u,v} is generated based upon a base sequence number u ∈{0,1, . . . ,29} received from the eNodeB 105.

In particular, the base sequence r̅_{u,v}(0), . . . , r̅_{u,v} (M_{SC}^{RS}−1) is given by

r̅_{u,v}(n)=x_{q}(nmodN_{ZC}^{RS}), 0≤n<M_{SC}^{RS}

where the q^{th} root ZC sequence is defined by

$${x}_{q} ( m ) = {e}^{- j \frac{π qm ( m + 1 )}{{N}_{ZC}^{RS}}} , 0 \leq m \leq {N}_{ZC}^{RS} - 1$$

with q given by

q=└q̅+½┘+v·(−1)^{└2q̅┘}

q̅=N_{ZC}^{RS}·(u+1)/31

Here M_{sc}^{RS}=4N_{sc}^{RB}=48, N_{ZC}^{RS}=47 and v=0 (due to M_{sc}^{RS}<6N_{sc}^{RB).}

At step 210, a plurality of blocks are generated from the base sequence. In particular, cyclic-shifts n_{SRS}^{cs} ∈{0,1, . . . ,n_{SRS}^{cs,max}} which are received from the eNodeB 105, are applied to the base sequence r̅_{u,v} as follows:

The cyclic shift sequence r_{u,v}^{(α\tilde{p})}(n) is defined by a cyclic shift α_{\tilde{p}} of a base sequence r̅_{u,v} (n) according to:

r_{u,v}^{(α\tilde{p})}(n)=e^{jα\tilde{p}n}r̅_{u,v}(n), 0≤n<M_{sc}^{RS}

The cyclic shift α_{\tilde{p}} of the sounding reference signal is given as:

$${α}_{\tilde{p}} = 2 π \frac{{n}_{SRS}^{cs , \tilde{p}}}{{n}_{SRS}^{cs , max}}$$

$${n}_{SRS}^{cs , \tilde{p}} = ( {n}_{SRS}^{cs} + \frac{{n}_{SRS}^{cs , max} \tilde{p}}{{N}_{ap}} ) mod {n}_{SRS}^{cs , max} , \\ \tilde{p} ∈ \{ 0 , 1 , … , {N}_{ap} - 1 \}$$

where n_{SRS}^{cs}∈{0,1, . . . , n_{SRS}^{cs,max}} and Nₐₚ is the number of antenna ports used for sounding reference signal transmission.

For n_{SRS}^{CS,max}=48, there are up to 48 orthogonal blocks.

At step 215, the SRS sequence is constructed by concatenation of the cyclically shifted blocks. In particular, the blocks are concatenated according to an instruction received from the eNodeB 105.

Advantageously, the method has Cubic Metric (CM), peak-to-power average ratio (PAPR), and cross-correlation properties, amongst overlapping SRS resources that are similar to in LTE.

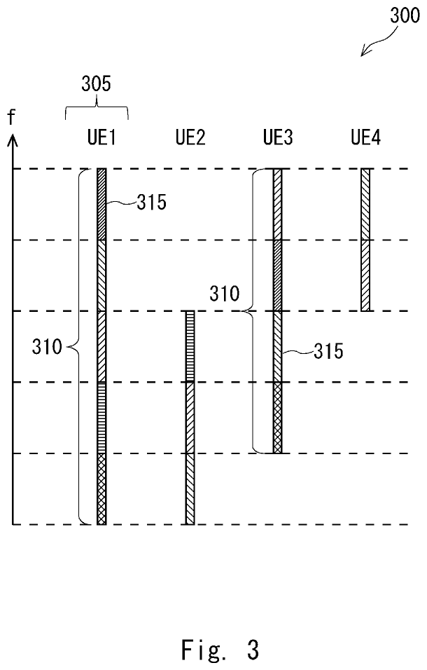

FIG. 3 illustrates an exemplary SRS sequence transmission diagram 300, according to an embodiment of the present invention.

The sequence transmission diagram illustrates transmission from four UEs 305 (UE1, UE2, UE3, UE4), each of which transmits an SRS sequence 310 comprising a plurality of cyclically shifted blocks 315 which are concatenated.

Each of the blocks 315 are aligned in the frequency domain, and each block 315 is orthogonal to the blocks 315 of the other UEs 305 at that frequency band.

The base sequence and the cyclic shift used by each UE at each block is signalled by the eNodeB 105 to the UEs 120. As such, the eNodeB 105 is able to ensure, through appropriate scheduling of SRS resources, that mutual orthogonality is maintained between the SRS resources of the different UEs. This is possible, as the same base sequence may be used by all UEs in a particular frequency band, but with a different cyclic shift.

Advantageously, the methods and systems described above enable mutual orthogonality to be maintained between SRS resources of the different UEs, which in turn enables more accurate uplink channel quality estimation. Furthermore, the method is aligned with existing LTE-based methods.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

This application is based upon and claims the benefit of priority from Australian provisional patent application No. 2017902832, filed on Jul. 19, 2017, the disclosure of which is incorporated herein in its entirety by reference.

### REFERENCE SIGNS LIST

100 MU-MIMO system
105 eNodeB
110, 125 antennas
120 UE

1. A method for transmitting sounding reference signals in a new radio (NR) communications system including an eNodeB and a plurality of UEs, the method including:
generating, at a UE, a base sequence based upon a sequence number received from the eNodeB;
generating a plurality of blocks from the base sequence by applying cyclic-shifts to the base sequence on a plurality of subcarrier groups;
generating a sounding reference signal by concatenating the cyclically shifted blocks; and
transmitting the sounding reference signal to the eNodeB;
wherein the plurality of blocks comprises 48 orthogonal blocks, and each of the plurality of blocks is 4 Physical Resource Blocks (PRBs) long.

2. The method of claim 1, wherein the base sequence r̅_{u ,v} is determined according to:
r̅_{u,v}(n)=x_{q}(nmodN_{ZC}^{RS}), 0≤n<M_{SC}^{RS},
where the q^{th} root Zadoff-Chu sequence is defined by
$${x}_{q} ( m ) = {e}^{- j \frac{π qm ( m + 1 )}{{N}_{ZC}^{RS}}} , 0 \leq m \leq {N}_{ZC}^{RS} - 1 ,$$
with q given by
q=└q̅+½┘+v·(−1)^{└2q̅┘}
q̅=N_{ZC}^{RS}·(u+1)/31
where the length N_{ZC}^{RS} of the Zadoff-Chu sequence is given by the largest prime number such that N_{ZC}^{RS}<M_{SC}^{RS}.

3. The method of claim 1, wherein the cyclically-shifted base sequence r_{u,v}^{(α\tilde{p})} (n) is determined according to:
r_{u,v}^{(α\tilde{p})}(n)=e^{jα\tilde{p}n}r̅_{u,v}(n), 0≤n<M_{SC}^{RS},
where α_{\tilde{p}} is the cyclic shift, and
wherein the cyclic shift o is determined according to:
$${α}_{\tilde{p}} = 2 π \frac{{n}_{SRS}^{cs , \tilde{p}}}{{n}_{SRS}^{cs , max}}$$
$${n}_{SRS}^{cs , \tilde{p}} = ( {n}_{SRS}^{cs} + \frac{{n}_{SRS}^{cs , max} \tilde{p}}{{N}_{ap}} ) mod {n}_{SRS}^{cs , max} , \\ \tilde{p} ∈ \{ 0 , 1 , … , {N}_{ap} - 1 \}$$
where n_{SRS}^{cs} ∈{0, 1, . . . , n_{SRS}^{cs,max}} and Nₐₚ is the number of antenna ports used for sounding reference signal transmission.

4. The method of claim 1, wherein the sounding reference signal is transmitted such that blocks thereof are aligned with blocks of sounding reference signals of other UEs.

5. The method of claim 1, wherein the cyclic shift used by each UE at each block is signalled by the eNodeB to the UEs.

6. The method of claim 1, wherein different cyclic shifts are used by different UEs in corresponding blocks.

7. The method of claim 1, wherein the same base sequence is used by the UEs in corresponding blocks.

8. The method of claim 1, wherein the eNodeB is configured to schedule SRS resources at each of the UEs such that mutual orthogonality is maintained between the SRS resources of the different UEs.

9. A new radio communications system including an eNodeB and a plurality of UEs, wherein each UE is configured to:
generate, a base sequence based upon a sequence number received from the eNodeB;
generate a plurality of blocks from the base sequence by applying cyclic-shifts to the base sequence;
generate a sounding reference signal by concatenating the cyclically shifted blocks; and transmit to the sounding reference signal to the eNodeB.
